(19) United States
(12) Patent Application Publication
(10) Pub. No.: US 2008/0186842 A1
(43) Pub. Date: Aug. 7, 2008

(54) DETECT-AND-MULTIPLEX TECHNIQUE FOR SPECTRUM SHARING

(75) Inventors: Chia-Chin Chong, Santa Clara, CA (US); Pedro C. Pinto, Cambridge, MA (US); Moe Z. Win, Framingham, MA (US); Fujio Watanabe, Union City, CA (US); Hiroshi Inamura, Cupertino, CA (US)

Correspondence Address: MACPHERSON KWOK CHEN & HEID LLP, 2033 GATEWAY PLACE, SUITE 400, SAN JOSE, CA, 95110, US

(73) Assignee: NTT DoCoMo. Inc.

(21) Appl. No.: 12/019,547

(22) Filed: Jan. 24, 2008

Related U.S. Application Data
(60) Provisional application No. 60/887,529, filed on Jan. 31, 2007.

(51) Int. Cl. H04J 9/00

(52) U.S. Cl. 370/204

(57) ABSTRACT

A wireless communication system and a detect-and-multiplex (DAM) spectrum sharing technique eliminate contention by secondary spectrum users by multiplexing multiple access methods. Suitable multiple access methods include time division multiple access (TDMA), frequency division multiple access (FDMA), code division multiple access (CDMA), space division multiple access (SDMA), orthogonal frequency division multiple access (OFDMA), spectral nulling (SN) or a hybrid scheme (HS) based on a combination of two or more of the above techniques. Unlike, detect-and-avoid (DAA) multiple access methods, the DAM method increases spectrum usage efficiency, and allows more users to share the same region of the spectrum.

### CROSS-REFERENCE TO RELATED APPLICATIONS

The present application is related to and claims priority of U.S. provisional patent application (“Provisional Application”), Ser. No. 60/887,529, entitled “Detect-and-Multiplex Technique for Spectrum Sharing,” filed on Jan. 31, 2007. The Provisional Application is hereby incorporated by reference in its entirety.

### BACKGROUND OF THE INVENTION

1. Field of the Invention

The present invention relates to wireless communication. In particular, the present invention relates to sharing a spectrum among many wireless users to improve efficiency.

2. Discussion of the Related Art

Various spectrum-sharing methods exist for increasing the efficiency or flexibility of spectrum usage, while decreasing the impact of interference. These methods are described, for example, in:

(a) U.S. Pat. No. 5,907,812, entitled “Method and Arrangement for Spectrum Sharing in a Radio Communication Environment,” to P. H. G. Van de Berg, issued on May. 25, 1999, discloses a method for flexible coexistence of several radio systems based on spectrum sensing. The method does not use a multiplexing method, but avoids channels that are being used.

(b) U.S. Pat. No. 5,412,658, entitled “Beacon Detection Method and Apparatus for Sharing Spectrum Between Wireless Communications Systems and Fixed Microwave Systems,” to H. W. Arnold, D. M. Devasirvathan, N. R. Sollenberger, L. G. Sutliff, and V. K. Varma, issued on May 2, 1995, discloses a spectrum sharing method for point-to-point and time division multiple access (TDMA) systems that is based on beacon detection.

(c) European Patent Application Publication, EP1220557A1, entitled “Communication System and Method of Sharing a Communication Resource,” by C. Faure, D. Calin, and T. L. Lee, filed on Dec. 29, 2000, discloses a method for dynamically sharing frequencies, both proprietary and shared, that is based on a detect-and-avoid (DAA) mechanism.

(d) U.S. Patent Application Publication, 2005/0095986, entitled “Spectrum Sharing in the Unlicensed Band,” by A. Hassan, P. Bahl, J. P. de Vries, filed on Oct. 30, 2003 and published on May 5, 2005, discloses a method for autonomous interferer detection and adaptation.

(e) U.S. Pat. No. 5,448,754, entitled “Radio Frequency Sharing Personal Communications System,” to C. M. P. Ho, and J. D. Lockton, filed Jan. 6, 1994, and issued on Sep. 5, 1995, discloses a frequency allocation scheme that is based on real-time interference sensing.

(f) U.S. Pat. No. 5,548,809, entitled “Spectrum Sharing Communication System and System for Monitoring Available Spectrum,” to P. H. Lemson, issued on Aug. 20, 1996, discloses a dynamic frequency allocation technique that is based on a deployed signal-level monitoring system.

(g) U.S. Pat. No. 5,497,503, entitled “Method for Assigning Frequency Channels in a Cellular Communication System and for Identifying Critical Existing Fixed Microwave Receivers that Restrict Operation of Such a System,” to J. T. Rydberg, and K. B. Hallman issued on Mar. 5, 1996, discloses a method for assigning frequency channels to base stations in a cellular communication system that is based on receiver clustering.

(h) U.S. Pat. No. 5,805,633, entitled “Method and Apparatus for Frequency Planning in a Multi-system Cellular Communication Network,” to J. Uddenfeldt, issued on Sep. 8, 1998, discloses an apparatus for frequency planning in a multi-system network, in which a number of systems operate in multiple frequency bands.

(i) U.S. Pat. No. 7,177,647, entitled “Spectrum Sharing Between Wireless Systems,” by M. Goldhammer, issued on Feb. 13, 2007, discloses a method for spectrum sharing that is based on time-frame allocation.

(j) U.S. Patent Application Publication 2006/0286934 A1, entitled “Method and Apparatus for Dynamic Spectrum Sharing,” by S. L. Kuffner, R. L. Peterson, and E. Visotsky, published on Dec. 21, 2006, discloses a technique for dynamic spectrum sharing that is based on node identification and measurement of local signal value.

The following references analyze DAA mechanisms for ultrawideband (UWB) interference mitigation, but do not disclose multiplexing alternatives for spectrum sharing: (k) “Detect and Avoid (DAA) Mechanisms for UWB Interference Mitigation,” by V. Somayazulu, J. Foerster, and R. Roberts, published in IEEE 2006 International Conference on Ultra-Wideband, pp. 513-518, September 2006; (l) “Performance of UWB Systems using a Temporal Detect-and-Avoid Mechanism,” by T. Zasowski, and A. Wittneben, published in IEEE 2006 International Conference on Ultra-Wideband, pp. 495-500, September 2006; (m) “Performance Evaluation of Detect and Avoid Procedures for Improving UWB Coexistence with UMTS and WiMAX systems,” A. Durantini, R. Giuliano, F. Mazzenga, and F. Vatalaro, published in IEEE 2006 International Conference on Ultra-Wideband, pp. 501-506, September 2006; (n) “Interference Mitigation for Coexistence of Heterogeneous Ultra-Wideband Systems”, Y. Zhang, H. Wu, Q. Zhang, and P. Zhang, published in EURASIP Journal on Wireless Communications and Networking, vol. 2006; (o) “Study of Coexistence between UWB and Narrowband Cellular Systems” M. Mittelbach, C. Muller, D. Ferger, A. Finger, published in Joint International Workshop on Ultra Wideband Systems and International Conference on Ultrawideband Systems and Technologies, pp. 40-44, May 2004.

(p) “Spectrum Pooling: An Inovative Strategy for the Enhancement of Spectrum Efficiency”, by T. A. Weiss, and F. K. Jondral, published in IEEE Communications Magazine, pp. 8-14, March 2004, discloses a concept of spectrum pooling which allows secondary utilization of already licensed frequency bands.

(q) “OverDRiVE-Spectrum Efficient Multicast Services to Vehicles”, R. Tönjes, K. Möβner, T. Lohmar, and M. Wolf, published in IST Mobile Summit, Thessaloniki, Greece, June 2002, discloses a hybrid network that ensures spectrum efficient provision of mobile multimedia services and enables interworking of cellular and broadcast networks in a common frequency range with dynamic spectrum allocation.

The prior art methods require that the secondary spectrum users contend for the spectrum when the primary owner of the spectrum is transmitting, and thus do not result in optimal spectrum usage. These methods do not use a multiplexing method to increase the spectral efficiency and thus, reduce the network capacity as less users can be supported by the fixed amount of spectrum. The methods are not flexible, requiring modification of the existing networks or special accommodation by the existing networks.

### SUMMARY

A wireless communication system and a detect-and-multiplex (DAM) spectrum sharing technique eliminate contention by secondary spectrum users by multiplexing multiple access methods. Suitable multiple access methods include time division multiple access (TDMA), frequency division multiple access (FDMA), code division multiple access (CDMA), space division multiple access (SDMA), orthogonal frequency division multiple access (OFDMA), spectral nulling (SN) or a hybrid scheme (HS) based on a combination of two or more of the above techniques. Unlike, DAA methods, the DAM method increases spectrum usage efficiency, and allows more users to share the same region of the spectrum.

According to one embodiment of the present invention, a method assigns, initially, a portion of a spectrum for exclusive use by a first user. The first user may then determine if a condition in the portion of the spectrum is favorable to allow one or more other users to communicate over the same portion of the spectrum using a multi-access method. To determine the channel condition, the first user detects the interference-plus-noise power in the portion of the spectrum, and enabling the other users when the interference-plus-noise power exceeds a predetermined threshold. The interference-plus-noise power may be detected using an adaptive scanning method selected from adaptive scanning methods having different update schedules.

The present invention is better understood upon consideration of the detailed description below in the conjunction with the accompanying drawings.

### BRIEF DESCRIPTION OF THE DRAWINGS

FIG. 1 illustrates a detect-and-multiplex (DAM) technique according to one embodiment of the present invention.

FIG. 2 illustrates in further detail exclusive operation mode 200, in accordance with one embodiment of the present invention.

FIG. 3 illustrates in further detail sharing operating mode 300, in accordance with one embodiment of the present invention.

FIG. 4 illustrates multiplexing multiple access schemes to allow spectrum sharing, according to one embodiment of the present invention.

FIG. 5 illustrates a spectrum scanning method, in accordance with an embodiment of the present invention.

### DETAILED DESCRIPTION OF THE PREFERRED EMBODIMENTS

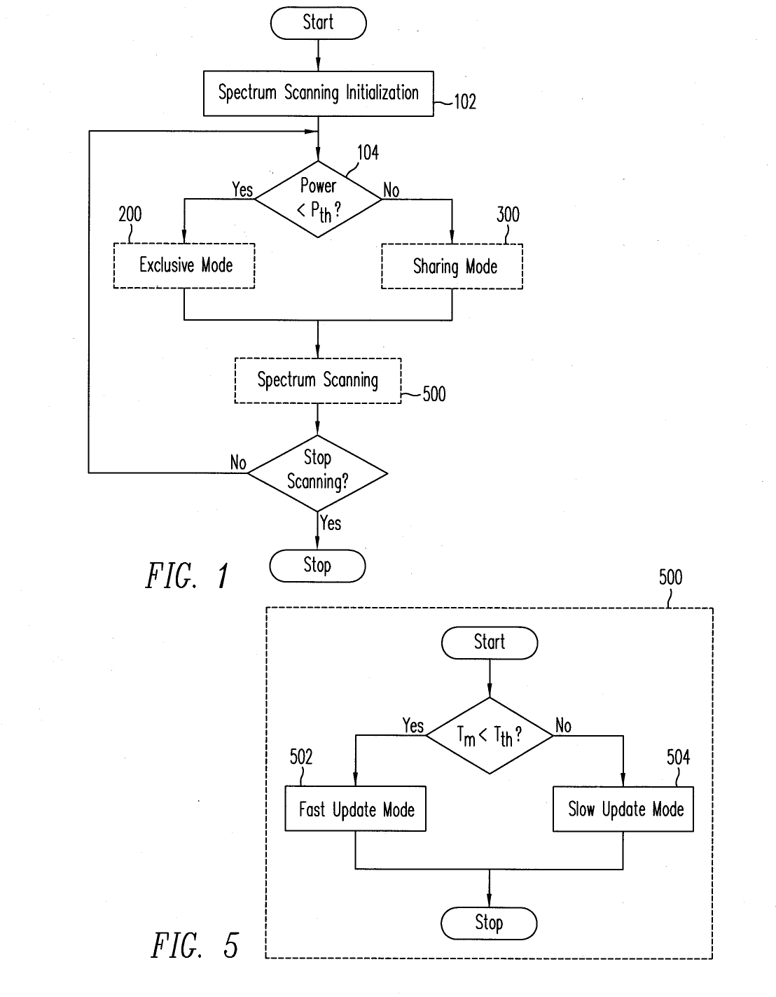

FIG. 1 illustrates a DAM technique according to one embodiment of the present invention. As shown in FIG. 1, the method includes (a) exclusive operating mode 200 and (b) sharing operating mode 300. After spectrum scanning initialization step 102, the interference-plus-noise power level is tested against a predefined threshold 104 to determine which of the operating modes should be used by the wireless system.

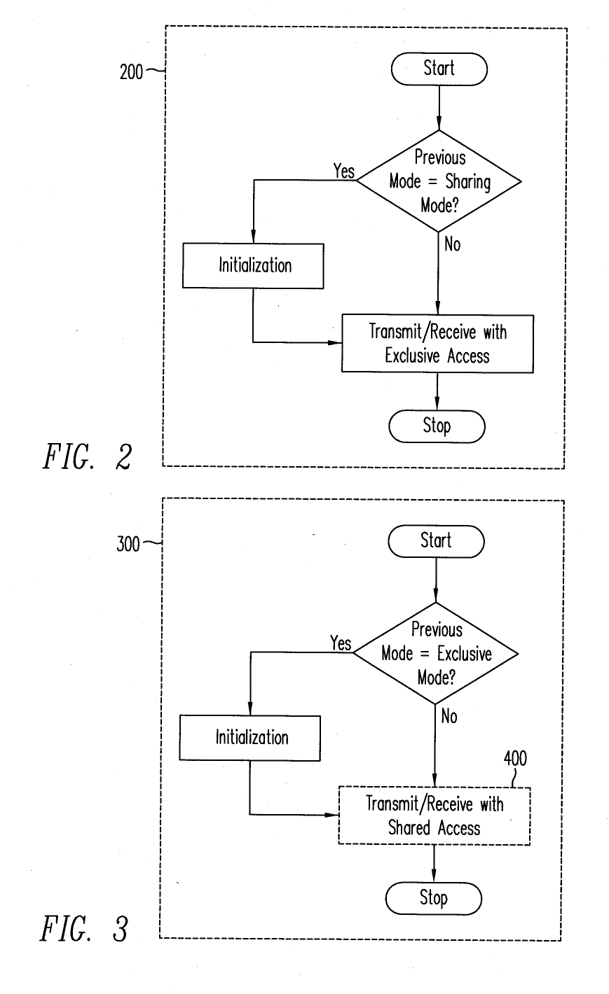

FIG. 2 illustrates in further detail exclusive operation mode 200, in accordance with one embodiment of the present invention. As shown in FIG. 2, when the previous operating mode is sharing operating mode 300, an initialization step is performed. Thereafter, the primary user is granted transmit and receive accesses to the given spectrum channel exclusively. Returning to FIG. 1, at spectrum scanning step 500, the exclusive primary user measures the interference-plus-noise power in its spectral band over a measure period Tₘ. When the power exceeds the predefined threshold Pₜₕ, the method switches to sharing operating mode 300.

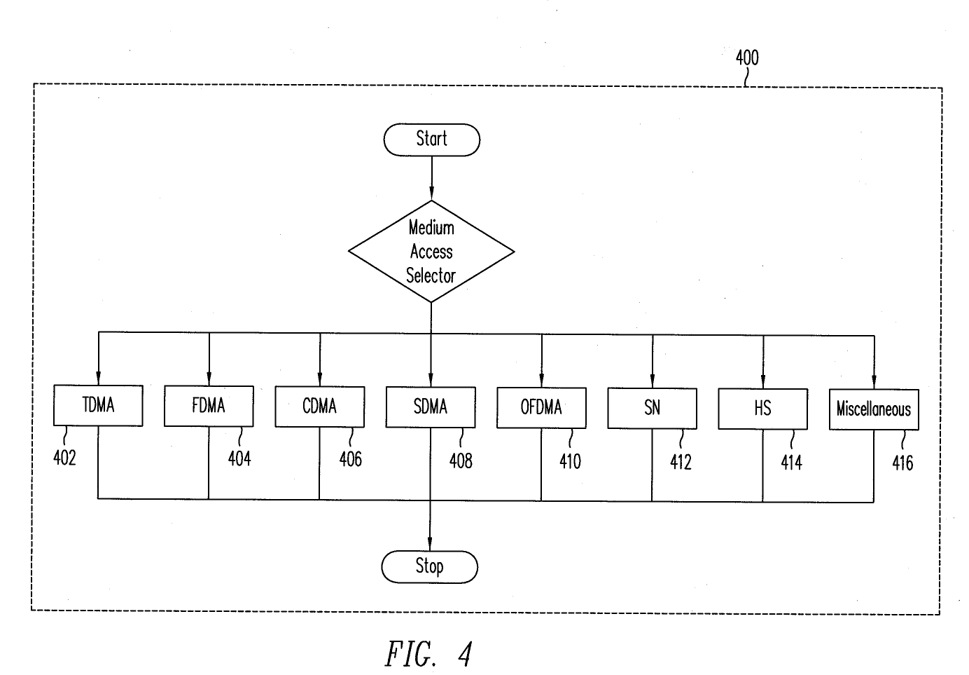

FIG. 3 illustrates in further detail sharing operating mode 300, in accordance with one embodiment of the present invention. As shown in FIG. 3, when the previous operating mode is exclusive operating mode 200, an initialization step is performed. Thereafter, multiple users i.e., both primary and secondary users are granted transmit and receive accesses to the given spectrum channel. In sharing operating mode 300, multiple users share the given spectrum channel using a predefined multiplexing strategy 400 (see, further detail in FIG. 4). Returning to FIG. 1, at spectrum scanning step 500, the interference-plus-noise power is monitored over measure period Tₘ. When the power falls below the threshold Pₜₕ, the method switches to exclusive operating mode 200.

The power threshold Pₜₕ is a system parameter that is determined at design time, and depends on the power transmitted by each mobile node, the thermal noise power, and the maximum allowable distance between two mobile nodes.

During the spectrum scanning process 500 (see FIG. 5), the measure period Tₘ is a system parameter which can be dynamically modified while the system is in operation. As shown in FIG. 5, spectrum scanning process 500 may be implemented by different measuring modes according to the duration of measure period Tₘ. If measure period Tₘ is selected to be shorter than a predefined threshold time Tₜₕ, fast update mode 502 measures interference-plus-noise power more frequently than under slow update mode 504. Fast update mode 502 ensures accurate and fast interferer detection, but requires more complex mobile node hardware and higher power consumption. The predefined threshold time Tₜₕ is selected based on channel conditions (e.g., fading, shadowing and Doppler effects), the mobility of the mobile nodes, and the session times of the mobile nodes.

Alternatively, under slow update mode 504, measure period Tₘ is longer than the predefined threshold time Tₜₕ, and the interference-plus-noise power is measured and updated only intermittently. Slow update mode 504 ensures simpler mobile node hardware and reduced power consumption, at the expense of accuracy and speed in the interferer detection.

In contrast to conventional DAA methods, a DAM method of the present invention does not require that the secondary spectrum users contend for the spectrum channel when the primary user is transmitting. As shown in FIG. 4, simultaneous medium access may be achieved through multiplexing the use of the spectrum using the following methods:
(a) Time Division Multiple Access (TDMA) 402. Under TDMA, users transmit in non-overlapping time slots. Time slots may be assigned to users dynamically or statically, and may be assigned deterministically or stochastically.
(b) Frequency Division Multiple Access (FDMA) 404. Under FDMA, users transmit in non-overlapping frequency slots. Frequency slots may be assigned to users dynamically or statically, and can be assigned deterministically or stochastically.
(c) Code Division Multiple Access (CDMA) 406. Under CDMA, users transmit using orthogonal codes, which may be dynamically or statically assigned to users.
(d) Space Division Multiple Access (SDMA) 408. Under SDMA, the physical locations of the transmitters (hence, their respective interference powers) is used to coordinate medium access.
(e) Orthogonal Frequency Division Multiple Access (OFDMA) 410. Under OFDMA, users are assigned subsets of sub-carriers, which allow simultaneous lower data rate transmissions from several users.
(f) Spectral Nulling (SN) 412. Under SN, each user monitors the spectrum to shape its transmitting signal. Specifically, the user introduces spectral nulls, as necessary, to minimize interference with the primary spectrum owner and secondary users.
(g) Hybrid Scheme (HS) 414. Under a hybrid scheme, users transmit using a combination of any of the six previous methods described in (a) to (f).
(h) Miscellaneous Scheme 416, representing new and future multiple access schemes.

A method of the present invention has the advantage that the secondary spectrum users need not contend for the spectrum while the primary user of the spectrum is transmitting. Relative to prior art DAA techniques, a DAM technique of the present invention increases spectrum usage efficiency, allowing more users to share a common region of the spectrum.

The detailed description above is provided to illustrate specific embodiments of the present invention and is not intended to be limiting. Numerous modifications and variations within the scope of the present invention are possible. The present invention is set forth in the following claims.

We claim:

1. A method for spectrum sharing comprising:
assigning a portion of the spectrum for use by a first user to communicate; and
based on a measurement of interference-plus-noise power in the portion of the spectrum, assigning the portion of the spectrum to a second user for a second user to communicate using a multi-access method.

2. A method as in claim 1, wherein the second user is assigned the portion of the spectrum when the interference-plus-noise power exceeds a predetermined threshold.

3. A method as in claim 2, wherein detecting interference-plus-noise power is carried out using an adaptive scanning method selected based on channel condition.

4. A method as in claim 3, wherein the adaptive scanning method is selected from a plurality of adaptive scanning methods having different update schedules.

5. A method as in claim 1, wherein the multiple-access method is selected from the group consisting of a time division multiple access scheme, a frequency division multiple access scheme, a code division multiple access scheme, a space division multiple access scheme, an orthogonal frequency division multiple access scheme, a spectral nulling scheme or a combination thereof.

6. A system for spectrum sharing comprising:
a first user assigned to communicate over a portion of the spectrum; and
a second user assigned, upon a favorable measurement of a interference-plus noise power, to communicate over the portion of the spectrum using a multi-access method.

7. A system as in claim 6, wherein the second user is assigned to the portion of the spectrum when the interference-plus-noise power exceeds a predetermined threshold.

8. A system as in claim 7, wherein the interference-plus-noise power is detected using an adaptive scanning method selected based on channel condition.

9. A system as in claim 8, wherein the adaptive scanning method is selected from a plurality of adaptive scanning methods having different update schedules.

10. A system as in claim 6, wherein the multiple-access method is selected from the group consisting of a time division multiple access scheme, a frequency division multiple access scheme, a code division multiple access scheme, a space division multiple access scheme, an orthogonal frequency division multiple access scheme, a spectral nulling scheme or a combination thereof.

11. A method carried out by a first user which is assigned a portion of a spectrum, comprising:
communicating over the portion of the spectrum exclusively;
determining a condition in the portion of the spectrum; and
enabling one or more other users to communicate over the portion of the spectrum using a multiple-access method.

12. A method as in claim 11, wherein determining the condition in the portion of the spectrum comprises detecting interference-plus-noise power in the portion of the spectrum, and enabling other users when the interference-plus-noise power exceeds a predetermined threshold.

13. A method as in claim 12, wherein detecting interference-plus-noise power is carried out using an adaptive scanning method selected based on channel condition.

14. A method as in claim 13, wherein the adaptive scanning method is selected from a plurality of adaptive scanning methods having different update schedules.

15. A method as in claim 11, wherein the multiple-access method is selected from the group consisting of a time division multiple access scheme, a frequency division multiple access scheme, a code division multiple access scheme, a space division multiple access scheme, an orthogonal frequency division multiple access scheme, a spectral nulling scheme or a combination thereof.
